(19) United States
(12) Patent Application Publication
(10) Pub. No.: US 2013/0242803 A1
(43) Pub. Date: Sep. 19, 2013

(54) IP BASED VIDEOCONFERENCE USING A SOCIAL NETWORK SERVER

(71) Applicants: Tarik Cicic, Strommen (NO); Haakon Bryhni, Olso (NO); Jan Marius Evang, Dal (NO); Richard Aas, Olso (NO)

(72) Inventors: Tarik Cicic, Strommen (NO); Haakon Bryhni, Olso (NO); Jan Marius Evang, Dal (NO); Richard Aas, Olso (NO)

(73) Assignee: MEDIA NETWORK SERVICES AS, Oslo (NO)

(21) Appl. No.: 13/877,139

(22) PCT Filed: Sep. 30, 2011
(86) PCT No.: PCT/GB2011/051855

§ 371 Date: May 29, 2013

(30) Foreign Application Priority Data
Sep. 30, 2010 (GB) 1016444.0

(51) Int. Cl. H04L 29/06

(52) U.S. Cl. CPC H04L 29/06326
USPC 370/254

(57) ABSTRACT

In the field of IP telephony, a video conference call is established between a calling node and a called node. Identification information relating to a calling party is transmitted to a connection server, which accesses a database of information relating to one or more parties and links between the parties. It uses the links to determine a set of parties depending on the identity of the calling party. It transmits identification information relating to the set of parties, and receives a selection from a user of a party from said set. It interrogates a database to determine a network address for one of the nodes and initiates a call with one of the nodes. It sends a call-transfer instruction to that node, which instructs the node to cease the call with the connection server and to transfer the call to the other node.

This invention relates to systems and methods for establishing an Internet Protocol (IP) telephony call between two or more parties, particularly, although not. exclusively, one which includes video.

Individuals and companies are increasingly using IP telephony systems to make voice and multimedia calls to other individuals or organisations. Calls are commonly routed over the public Internet, but can alternatively travel over a private IP network. IP telephony has a number of widely-recognised advantages over the traditional public switched telephone network (PSTN), such as multi-party calls and video conferencing.

In current systems, to initiate an IP telephony session, it is necessary for the calling party's equipment to know the network address and possibly a port number associated with the called party's equipment. Typically the calling party will use its IP telephony equipment to access a corporate directory service hosted on a private server in which such details have previously been stored for a limited group of employees and clients of that particular corporation.

In order to call someone who is not already in a preconfigured directory, the calling party must typically first discover the network address of the intended recipient's IP telephony node by some separate channel, such as email. This address must then be entered into the caller's telephony endpoint, for example, via a keypad. The caller might, for example, be required manually to type an address URI such as “sip:user@company.com” into his IP telephony system before a call can be made. Occasionally a port number might also be required. Such a process is slow and burdensome, and can be prone to mistakes.

The present invention takes a different approach to initiating IP telephony calls which seeks to avoid such shortcomings.

From a first aspect, the invention provides a method of establishing an IP telephony call between a calling IP telephony node and at least one called IP telephony node comprising:
sending identification information relating to the calling IP telephony node to a connection server;
sending identification information relating to the called IP telephony node to a connection server;
the connection server interrogating a database to determine a network address for at least one of the calling IP telephony node and the called IP telephony node;
the connection server initiating a call with a first node selected from the calling and called IP telephony nodes; and
the connection server sending a call-transfer instruction to the first node, which instructs the node to cease the call with the connection server and to transfer the call to a second of the calling and called IP telephony nodes.

The invention extends to a connection server for establishing an IP telephony call between a calling IP telephony node and at least one called IP telephony node, the server being configured to:
receive identification information relating to the calling IP telephony node;
receive identification information relating to the called IP telephony node;
interrogate a database to determine a network address for at least one of the calling IP telephony node and the called IP telephony node;
initiate a call with a first node selected from the calling and called IP telephony nodes; and
send a call-transfer instruction to the first node, which instructs the node to cease the call with the connection server and to transfer the call to a second of the calling and called IP telephony nodes.

The invention extends to a system comprising two or more IP telephony nodes and a connection server configured as above.

The invention extends to computer software, and to a carrier bearing the same, which, when run on a connection server, causes it to:
receive identification information relating to the calling IP telephony node;
receive identification information relating to the called IP telephony node;
interrogate a database to determine a network address for at least one of the calling IP telephony node and the called IP telephony node;
initiate a call with a first node selected from the calling and called IP telephony nodes; and
send a call-transfer instruction to the first node, which instructs the node to cease the call with the connection server and to transfer the call to a second of the calling and called IP telephony nodes.

Thus it will be seen by those skilled in the art that, in accordance with the invention, an IP telephony call can be established between nodes or endpoints without the user at the calling endpoint having to discover and enter details of the called party's IP telephony node (such as a network address and port number). Instead, a user can identify themself to a connection server, for example by entering a username or other credentials to a web server linked to the connection server. The user can then indicate to the connection server a second party whom they wish to call, e.g. by selecting a username from a list of personalised contacts displayed on a web browser. The connection server then uses the identification of the second party to retrieve from a database a network address of an IP telephony node associated with the second party and automatically establishes a call connection between the two parties' endpoints by means of the call-transfer instruction.

Call-transfer is known in the field of IP telephony and allows a call to be redirected or transferred from one party to another. In the Internet Engineering Task Force (IETF)'s Session Initiation Protocol (SIP), call transfer is implemented using the REFER method. It is intended to be used when, for example, a call from a client of a company is answered by the company's receptionist. After speaking with the client to determine who best should handle the enquiry, the receptionist can transfer the client's call to the relevant employee. At the network level, the receptionist's actions cause a call-transfer instruction containing the network address of the relevant employee's telephony endpoint to be transmitted to the client's endpoint. The client's endpoint responds by ceasing the call with the receptionist's endpoint, and transferring the call to the relevant employee's endpoint. The client can then communicate directly with the relevant employee.

The present invention, however, uses call-transfer in a completely different and counterintuitive way. Rather than a call-transfer instruction being issued in response to a user action, indicating to the system that a call should be transferred to someone else, in the present invention, a call-transfer instruction is issued automatically by a connection server. Moreover, the call-transfer instruction is issued by the initiator of the call, rather than by the first recipient of the call, as in the typical scenario presented above.

A significant advantage of this arrangement is that it can be used with all existing endpoints without modification, so long as they support a suitable call-transfer instruction. This contrasts with existing endpoint-directory-based approaches described previously, or with using proprietary remote procedure calls (RPCs) to instruct one endpoint to call another directly. SIP is one of the most widely used initiation protocols, and does provide just such a call-transfer instruction. H.323, another widely-used protocol, provides similar functionality. There is therefore typically no need for the endpoints to be modified (e.g. by installing new directory-based services and the hardware necessary to interface with them) in order to implement the invention. In some preferred embodiments, the call-transfer instruction comprises a SIP REFER request, as described in IETF RFC 3515.

The concept of a “call” can refer to a media stream between two users, but is also here used more broadly to refer to data exchanges relating to session initiation and control protocols. For example, the call that is initiated between the connection server and a telephony node may only convey one or more control commands, without any audio of graphical data ever being sent. Thus, in some embodiments, the connection server may initiate the call with a node by the act of sending a call-transfer instruction, without any preliminaries. However, it is envisaged that, more commonly, session initiation data or other communications would be transmitted before the call-transfer instruction. In some embodiments, a call may be ceased simply by no longer sending any traffic relating to that session.

A calling party could send the identification information for the calling IP telephony node and/or the called IP telephony node via the calling party's IP telephony node. This would at least mean that the identification information relating to the calling party could include the network address of the calling party's IP telephony node.

However one of the important advantages that can be achieved in accordance with preferred embodiments of the invention is that this is not necessary. Thus in preferred arrangements, the identification of a calling IP telephony node and/or the called IP telephony node to the connection server can be made using a device not forming part of any IP telephony apparatus such as the calling IP telephony node. For example, a user may identify a party (themself as calling party or another party as called party) by means of a handheld device such as a mobile telephone, or by using a personal computer. The identification of a party, such as a human user, constitutes information relating to an IP telephony node so long as an association exists between the party and a particular node or endpoint.

Such an arrangement can avoid the need for a user to interact in a control sense with IP telephony apparatus whatsoever, which can increase convenience and user acceptance. For example, without the present invention, a user might be required to use a proprietary infrared remote control to instruct an endpoint to initiate an IP call via on-screen menus and fiddly buttons. With the present invention, it is possible to establish a call from the familiar environment of a user's mobile telephone or PC. Moreover, the user need not be physically present in the same room as the endpoint equipment in order to initiate an IP call.

In preferred embodiments, the connection server receives identification information relating to the called party (such as a username) and uses this to interrogate a database to receive a network address of an associated IP telephony node to call (the called IP telephony node). Optionally but preferably the connection server also receives identification information relating to the calling party and uses this to interrogate a database, which may be different to the one mentioned above but is preferably the same, to receive a network address of the calling IP telephony node.

The connection server may comprise, or be operably connected to, an interaction server configured to receive the identification information relating to the called and/or calling IP telephony nodes, such as identity information relating to called and/or calling party or parties. The interaction server may receive such identification information by Hypertext Transfer Protocol (HTTP), which is widely supported by devices such as mobile telephones; although any suitable protocol may be used. The interaction server can then interact with the database to obtain the corresponding network address from the identification information. For example, the interaction server might receive an indication of a username associated with a party, but might transmit a network address of an endpoint associated with the party to the connection server.

In one preferred set of embodiments, the connection server, optionally via an interaction server, is configured to: transmit, to a user, identification information relating to a set of parties having associated IP telephony node network addresses; receive a selection from the user of at least one party from said set; and use said selection to allow the connection server to determine an IP telephony node network address corresponding to the selected party. The identification information relating to the set of parties may include their network addresses such that upon said selection being made no further database interrogation is necessary, or a network address may only be returned for the selected party or parties. The identification information relating to the set of parties may therefore be held in a database different from that which holds network addresses thereof, but preferably it is the same.

The set of identification information may be transmitted by HTTP, for example as an HTML page. The server may be configured to receive an identification of a first party, and to determine the set of parties to transmit in dependence on the identity of the first party. For example, a user may log in to the server and be presented with a list of contacts, such as the names or photographs of acquaintances or colleagues or previously-called users.

The connection server may thus comprise, or have access to, a database of information relating to one or more parties. The database may be hosted on a separate server, remote from the connection server, or it may be integral therewith. It may contain user information, such as names, nicknames, photographs, etc. It may contain endpoint information, such as network addresses, port numbers, protocol information, bandwidth information, etc. It may contain information relating to associations between users and endpoints. It may contain security information, such as passwords, cryptographic keys, etc. It may contain billing or financial information, such as the amount of credit a user has for making calls.

In one particularly preferred set of embodiments, the database comprises links between parties, e.g. representing social connections and forming a social network. These links may be used when determining a set of parties whose identities are to be transmitted to a user. For example, a user may only be presented with details of other users with whom she is linked within the database. The database may be part of an existing social network, such as Facebook® or Linkedln®, with which the connection server communicates.

Such an arrangement is considered particularly desirable. It allows social media mechanisms, such as online contact networks, black-lists, log-in security, etc. to be used both to share and to restrict access to videoconferencing address information. Information can be shared by using a person's social media graph (all the people known to that person according to the social media database) to promote and share video addresses for that person but also for other people he knows. Restrictions may be made by requiring a social media connection to exist between two users before one of the user's videoconferencing information is shared with the other.

The Applicant has appreciated that by exploiting a database of predetermined relationships, a user may be presented with the option to call only those parties that have consented to the relationship being recorded. This makes it more acceptable for IP telephony node network addresses to be propagated throughout the database without having to be explicitly shared by the party with whom they are associated. For example in accordance with a preferred embodiment users may enter their own IP telephony node network address (or addresses) into their social networking profile, or others who know this information may do so for them (e.g. in order to call them). This network address will then automatically be available to all of the user's existing connections and any that are subsequently added. This allows for rapid and convenient population of this information in the database.

This approach to distributing videoconferencing addresses is novel in its own right and thus, from a further aspect, the invention provides a method of transmitting to a first user an IP videoconferencing endpoint address associated with a second user, comprising:
a third user creating an association between the endpoint address and the second user on a social network server, the social network server having access to data records related to a plurality of respective users and further having access to links between pairs of said data records;
the first user requesting the endpoint address of the second user from the social network server; and
the social network server determining whether the first user and the second user have respective records which are linked together, and sending the endpoint address to the first user if the records are so linked.

From another aspect the invention provides a social network server that has access to data records related to a plurality of respective users, including first, second and third users, and further has access to links between pairs of said data records, the server being configured to:
store an association between the second user and an IP videoconferencing endpoint address, in response to an instruction received from the third user;
receive a request from the first user for the endpoint address of the second user; and
determine whether the first user and the second user have respective records which are linked together, and send the endpoint address to the first user if the records are so linked.

The social network server may refuse to send the endpoint address to the first user if the records are not linked.

In this way, videoconferencing endpoint addresses can be efficiently propagated throughout a network of friends of acquaintances in a viral manner, without the privacy concerns that might arise from making the addresses available to the general public.

In any of the foregoing aspects, the connection server may comprise or be connected to a scheduling component that allows a party to arrange a call for a future time. The connection server may then be configured so as to issue the call-transfer instruction at a time corresponding to the scheduled time.

For a two-party call the IP telephony nodes will typically be endpoints—e.g. having means for receiving sound and/or video. However this is not essential. In a set of embodiments at least one of the IP telephony nodes comprises a multipoint control unit (MCU), or a conference session hosted by an MCU. An MCU is a known apparatus that provides an IP telephony bridging service, in order to allow three or more participants to communicate with each other in a multi-party conference session. The conference session is typically set up by establishing a set of bilateral call connections between the MCU and each of the relevant endpoints, in a star topology with the MCU at the centre. The MCU manages the various call connections to allow each party to exchange data, such as voice and video data, with the other parties in the conference. Typically, each participant's endpoint is provided with a video and sound feed from every other endpoint.

The present method can therefore be used to establish an IP telephony call between a first party, or user, and an MCU. The call-transfer instruction may be sent either to the first party or to the MCU. Preferably, it is sent to the MCU, since this may be more reliable, because it can be more-easily ensured that the MCU supports the call-transfer instruction, whereas support for the instruction by the other node may not be known in advance.

In some embodiments, it might be necessary to provide the connection server with identification of an MCU, or session on an MCU. The identification of the MCU or session may take any appropriate form, such as the name of a server, chat room, or conference-call ID. Such identification may or may not be associated with one of the endpoints. However, it may not always be necessary to identify the MCU to the connection server. This would be the case if the connection server were preconfigured to use a particular MCU by default, for example. In this case, the step of sending identification information relating to the MCU telephony node may be carried out implicitly by not sending any explicit alternative identification information for that node.

The method of the invention may be carried out any number of times, in respect of the same MCU or session, for additional parties. The method steps may be performed simultaneously, overlappingly or consecutively, as appropriate. Even when a conference session is already underway, an additional user may still be connected to the session by establishing a call with the MCU in accordance with the present invention.

Accordingly, when employing an MCU to connect two or more participating IP telephony endpoints, the method may comprise establishing an IP telephony call between a first endpoint and a second endpoint by sending identification information relating to the first and second endpoints to a connection server, wherein the connection server:
initiates an IP telephony call with either an MCU or the first endpoint;
sends a call-transfer instruction to the MCU or the first endpoint, which instructs the telephony apparatus to cease the call with the connection server and to transfer the call to the other of the MCU and the first endpoint;
initiates an IP telephony call with either the MCU or the second endpoint; and
sends a call-transfer instruction to the MCU or the second endpoint, which instructs the telephony apparatus to cease the call with the connection server and to transfer the call to the other of the MCU and the second endpoint.

Certain preferred embodiments of the invention will now be described, by way of example only, with reference to the accompanying drawings, in which:

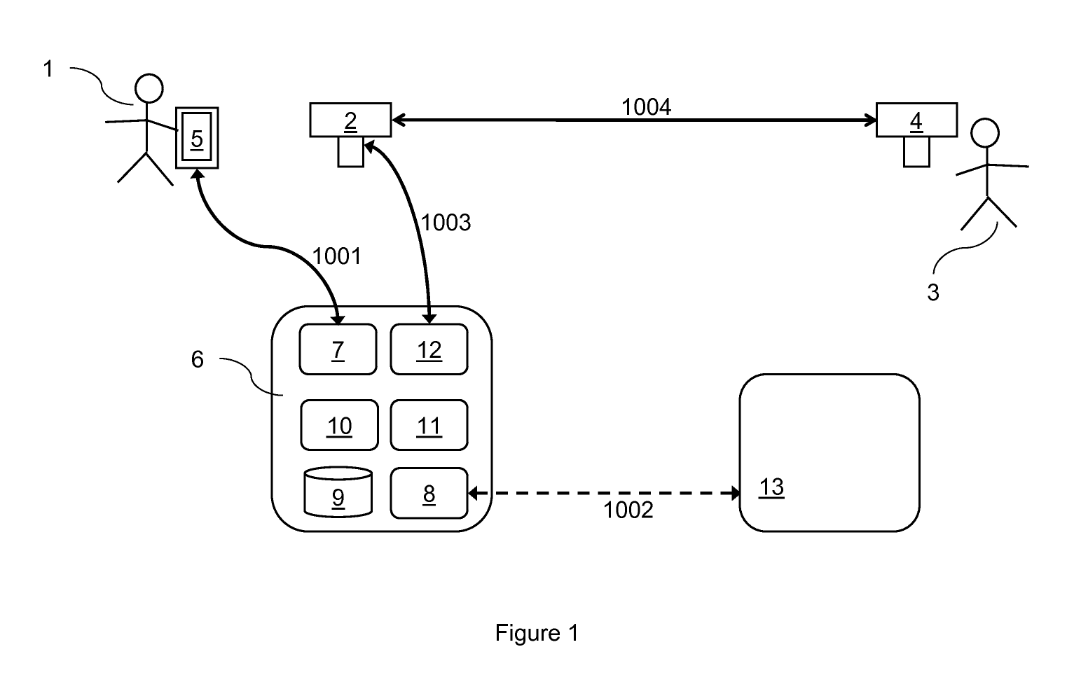

FIG. 1 is a schematic diagram illustrating the participants in and steps of a two-party call initiation process embodying the invention; and

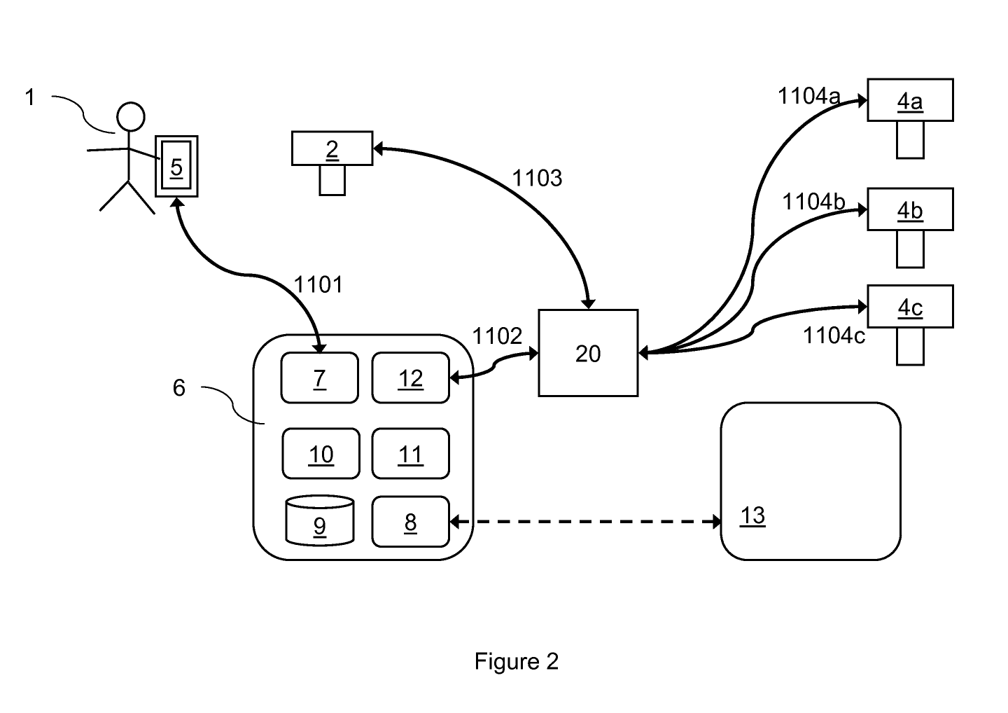

FIG. 2 is a schematic diagram illustrating the participants in and steps of a multi-party call initiation process embodying the invention.

FIG. 1 shows a human user 1 with a SIP videoconferencing endpoint 2. The user 1 may already be in the same room as the endpoint 2, e.g. sitting at a table in a videoconferencing suite, but he could be situated elsewhere. Another human user 3 is by a different SIP videoconferencing endpoint 4. Although the users are shown as human beings, they could be other physical or abstract entities such as meeting rooms, technical-support departments, companies, etc.

The two users may be friends or business acquaintances, and may be in different rooms in the same building, or in different countries or continents to each other. The first user 1 holds a mobile telephone 5 equipped with an Internet web browser.

A videoconferencing directory service 6 is made up of several logical components. These components may all be implemented in one server, or may be distributed across multiple different servers, possibly in different locations to each other. Collectively these form a connection server in accordance with the invention. The components include a web server 7; a social-network interface component 8; a contacts database 9; a call scheduler 10; an authentication client 11; and a connection server 12.

The web server 7 provides an HTML interface to the directory service 6 which is accessible over the Internet, e.g. using a mobile handset 5 held by the first user 1.

The social-network interface component 8 is connected to a public, social network provider 13, such as Facebook® or Linkedln®. The interface component 8 can extract information from the social network provider 13 which can be used to propagate the contacts database 9.

In use, the first user 1 can access 1001 the web server 7 via a web browser on her mobile telephone 5. Of course, other forms of access are also possible. When first registering with the system, a user can provide credentials for an existing account with the social network provider 13, which may be relayed by the social-network interface component 8, or passed directly to the social network provider 13, with an instruction authorising access to the user's social network by the directory service 6. The authentication client 11 can authenticate the telephony address of a given user during the registration process, or later when information is updated, in order to prevent spoofing. The interface component 8 receives 1002 identity information relating to some or all of the user's social contacts. This information may already contain telephony endpoint information, such as a contact's SIP address, but this will not always be available. Thus, a copy of the information is kept in the contacts database 9, which users can supplement with additional information such as telephony endpoint details for themselves or other users. Such information can be added and edited via the web server 7.

The social-network interface component 8 may access the social network provider 13 at intervals to update the database 9 with any new or changed data.

To initiate an IP telephony call with the second user 3, the first user 1 can either request an immediate call or schedule a call for a later time using the call scheduler 10. The first user 1 can send these instructions to the directory service 6 via the web browser on her mobile telephone 5. After logging in to the directory server 6, the first user 1 selects a representation of the second user 3 by searching the contacts database 9 or by choosing from a list of friends presented to her by the web server 7. The user representation may include a real name, nickname, photograph, or any other suitable identifiers.

When the time comes for the call to be established, the database 9 provides the address of a videoconferencing endpoint 4 associated with the selected second user 3 to the connection server 2. The connection server 12 then sends 1003 a SIP REFER request to the first user's videoconferencing endpoint 2, which instructs it to connect to the endpoint 4 associated with the second user 3. The REFER request might be sent after an earlier INVITE request issued by the connection server 12 to the first user's endpoint 2, or it might be sent outside the scope of a dialog created with an INVITE (although this is envisaged as being less common).

Alternatively, the connection server 12 could be set up to contact the second user's endpoint 4 first, and issue it with a REFER request containing details of the first user's endpoint 2. However, this is less preferred since some endpoints may be configured to request approval from a user before acting on a REFER request, which could be confusing to the second user 3 if he is not aware that a call has been planned. The first user 1, should be aware that a call is being initiated, so will not be confused if her endpoint 2 requests her to approve the referral.

Once the first user's endpoint 2 receives the REFER request, and optionally obtains approval from the first user 1, it issues a “202 Accepted” response and a NOTIFY response to the connection server 12, and establishes a media session 1004 with the second user's endpoint 4. The first user's endpoint 2 is preferably configured with a policy that accepts REFER requests from the connection server 12 without needing to seek approval from the user 1, to make the experience as seamless as possible.

The first user 1 and second user 3 are then able to proceed with their videoconference call.

FIG. 2 shows how a multi-party videoconference session can be established. The directory service 6 is unchanged from before. However, an MCU 20 is used to provide the multi-party support. This MCU 20 may be a component of the directory service 6, e.g. hosted in the same building, or it may be separate.

Rather than simply selecting one user, the first user 1 this time uses her mobile telephone 5 to interact 1101 with the directory service 6, via the web server 7, in order to select a plurality of endpoints 4a, 4b, 4c associated with relevant users (not shown). The user may also select a virtual meeting room, hosted by the MCU 20.

Either immediately or at a time determined by the call scheduler 10, the connection server 12 issues a set of REFER requests to the MCU 20, instructing it to establish respective media sessions with the first user's endpoint 2 and the plurality of other endpoints 4a, 4b, 4c. (Alternatively, the connection server 12 could issue the REFER requests to the endpoints 2, 4a, 4b, 4c instructing them to establish sessions with the MCU 20.) Details of the chosen virtual meeting room may be sent by the connection server 12 as appropriate.

As the endpoints 2, 4a, 4b, 4c respond to the REFER requests, they will become connected directly to the MCU 20, which can integrate them into the multi-party conferencing session.

1. A method of establishing an IP videoconference call between a calling IP videoconference node and at least one called IP videoconference node, comprising:
sending identification information relating to a calling IP videoconference node to a connection server by transmitting to the connection sever identification information relating to a calling party associated with the calling IP videoconference node;
the connection server accessing a database of information relating to one or more parties and links between the parties, and using said links to determine a set of parties in dependence on the identity of the calling party, the set of parties having associated IP videoconference node network addresses;
the connection server transmitting, to a user, identification information relating to the set of parties;
the connection server receiving identification information relating to a called IP videoconference node by receiving a selection from the user of at least one party from said set;
the connection server interrogating a database to determine a network address for at least one of the calling IP videoconference node and the called IP videoconference node;
the connection server initiating a call with a first node selected from the calling and called IP videoconference nodes; and
the connection server sending a call-transfer instruction to the first node, which instructs the node to cease the call with the connection server and to transfer the call to a second of the calling and called IP videoconference nodes.

2. The method of claim 1 wherein the call-transfer instruction comprises a Session Initiation Protocol REFER request.

3. (canceled)

4. The method of claim 1 wherein the identification information relating to the calling IP videoconference node is sent using a device other than the calling IP videoconference node.

5. (canceled)

6. The method of claim 1 comprising the connection server receiving identification information relating to a calling or called party and using this information to interrogate a database to receive a network address of an IP videoconference node associated with the calling or called party.

7. (canceled)

8. (canceled)

9. The method of claim 1 wherein the identification information relating to the calling IP videoconference node or called IP videoconference node comprises a username.

10. The method of claim 1 wherein the connection server comprises or is operably connected to an interaction server, comprising the interaction server receiving identification information relating to the called IP videoconference node or calling IP videoconference node by Hypertext Transfer Protocol.

11. (canceled)

12. The method of claim 1 comprising transmitting the identification information relating to the set of parties by Hypertext Transfer Protocol.

13. The method of claim 1 wherein the connection server issues the call-transfer instruction at a time corresponding to a scheduled call time.

14. (canceled)

15. The method of claim 1 wherein at least one of the calling IP videoconference node and the called IP videoconference node comprises a multipoint control unit (MCU).

16. The method of claim 15 wherein said first node comprises the MCU, such that the call-transfer instruction is sent to the MCU.

17. The method of claim 15 comprising establishing an IP videoconference call between a first endpoint and a second endpoint by sending identification information relating to the first and second endpoints to the connection server, wherein the connection server:
initiates an IP videoconference call with either the MCU or the first endpoint;
sends a call-transfer instruction to the MCU or the first endpoint, which instructs the videoconference apparatus to cease the call with the connection server and to transfer the call to the other of the MCU and the first endpoint;
initiates an IP videoconference call with either the MCU or the second endpoint; and
sends a call-transfer instruction to the MCU or the second endpoint, which instructs the videoconference apparatus to cease the call with the connection server and to transfer the call to the other of the MCU and the second endpoint

18. A connection server for establishing an IP videoconference call between a calling IP videoconference node and at least one called IP videoconference node, the server being configured to:
receive identification information relating to a calling IP videoconference node by receiving identification information relating to a calling party associated with the calling IP videoconference node;
access a database of information relating to one or more parties and links between parties; and
use said links to determine a set of parties in dependence on the identity of the calling party, the set of parties having associated IP videoconference node network addresses;
transmit, to a user, identification information relating to the set of parties; receive identification information relating to a called IP videoconference node by receiving a selection from the user of at least one party from said set; interrogate a database to determine a network address for at least one of the calling IP videoconference node and the called IP videoconference node;
initiate a call with a first node selected from the calling and called IP videoconference nodes; and
send a call-transfer instruction to the first node, which instructs the node to cease the call with the connection server and to transfer the call to a second of the calling and called IP videoconference nodes.

19. The connection server of claim 18 wherein the call-transfer instruction comprises a Session Initiation Protocol REFER request.

20. (canceled)

21. The connection server of claim 18 configured to:
receive identification information relating to a calling or called party; and
use this information to interrogate a database to receive a network address of an IP videoconference node associated with the calling or called party.

22. (canceled)

23. (canceled)

24. The connection server of claim 18 wherein the identification information relating to the calling IP videoconference node or called IP videoconference node comprises a username.

25. The connection server of claim 18 comprising, or configured to connect to, an interaction server which is configured to receive identification information relating to the called IP videoconference node or calling IP videoconference node by Hypertext Transfer Protocol.

26. (canceled)

27. (canceled)

28. The connection server of claim 18 configured to transmit the identification information relating to the set of parties by Hypertext Transfer Protocol.

29. The connection server of claim 18 configured to issue the call-transfer instruction at a time corresponding to a scheduled call time.

30. (canceled)

31. The connection server of claim 30 further comprising a database of information relating to one or more parties, the database containing information selected from the group consisting of: usernames, user nicknames, user photographs, endpoint network addresses, endpoint port numbers, endpoint protocol information, endpoint bandwidth information, associations between users and endpoints, links between parties, passwords, cryptographic keys, billing information, and financial information.

32. A non-transitory, computer-readable storage medium comprising instructions which, when run on a connection server, cause the connection server to:
receive identification information relating to a calling IP videoconference node by receiving identification information relating to a calling party associated with the calling IP videoconference node;
access a database of information relating to one or more parties and links between parties; and
use said links to determine a set of parties in dependence on the identity of the calling party, the set of parties having associated IP videoconference node network addresses;
transmit, to a user, identification information relating to the set of parties; receive identification information relating to a called IP videoconference node by receiving a selection from the user of at least one party from said set; interrogate a database to determine a network address for at least one of the calling IP videoconference node and the called IP videoconference node;
initiate a call with a first node selected from the calling and called IP videoconference nodes; and
send a call-transfer instruction to the first node, which instructs the node to cease the call with the connection server and to transfer the call to a second of the calling and called IP videoconference nodes.

33. (canceled)

34. (canceled)

35. (canceled)

36. (canceled)
